(19) United States
(12) Patent Application Publication
(10) Pub. No.: US 2012/0322276 A1
(43) Pub. Date: Dec. 20, 2012

(54) ELECTRONIC DEVICE WITH CONNECTOR

(75) Inventors: Tsung-Hsi LI, Tu-Cheng (TW); Ming-Chih HSIEH, Tu-Cheng (TW)

(73) Assignee: HON HAI PRECISION INDUSTRY CO., LTD., Tu-Cheng (TW)

(21) Appl. No.: 13/272,236

(22) Filed: Oct. 13, 2011

(30) Foreign Application Priority Data
Jun. 17, 2011 (TW) 100121151

(51) Int. Cl. H01R 12/00

(52) U.S. Cl. 439/55

(57) ABSTRACT

An electronic device includes a housing, a circuit board arranged in the housing, a first connector, and a second connector. The first connector includes a panel formed at a first end of the first connector and located at an outer surface of the housing. The panel defines a number of first sockets to. A number of pins extend from a second end of the first connector. The second connector includes a first connecting portion and a second connecting portion. The first connecting portion defines a number of sockets to connect the pins of the first connector. The second connecting portion includes a number of pins connected to the circuit board.

### BACKGROUND

1. Technical Field

The present disclosure relates to an electronic device having connectors.

2. Description of Related Art

Electronic device usually includes a plurality of external interfaces. The external interfaces are electrically connected to a circuit board in the electronic device through cables, which is inconvenient in disassembling or repairing the electronic device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded, isometric view of an exemplary embodiment of an electronic device, wherein the electronic device includes a first connector and a second connector.

FIG. 2 is an enlarged view of the second connector of FIG. 1.

FIG. 3 is an assembled, isometric view of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

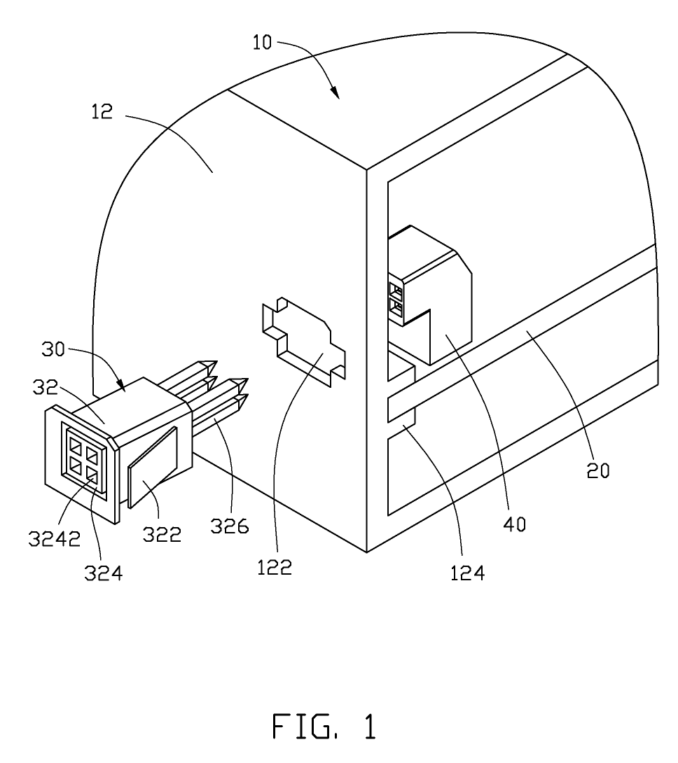

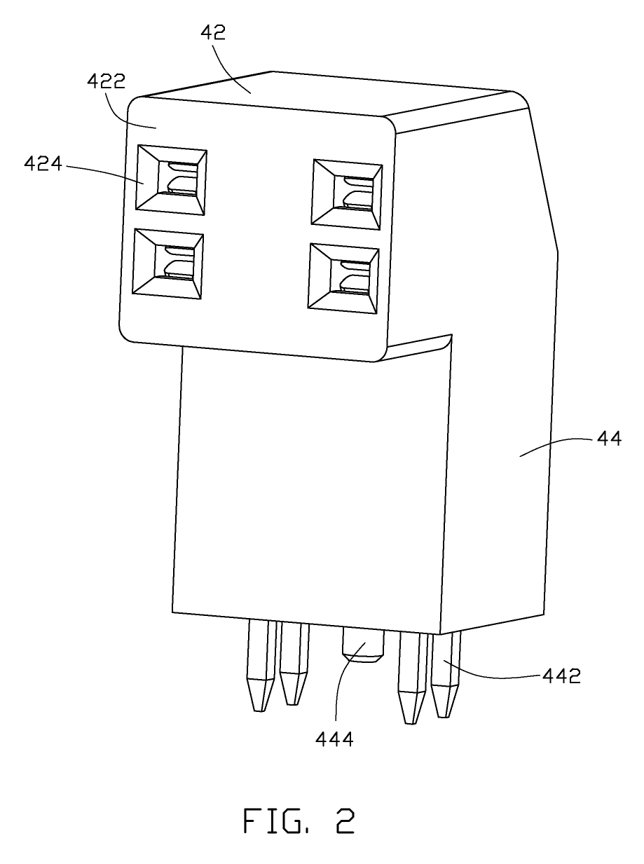

Referring to FIG. 1 and FIG. 2, an embodiment of an electronic device includes a housing 10, a circuit board 20, a first connector 30, and a second connector 40.

The housing 10 includes a sidewall 12 defining a through hole 122. A U-shaped locking portion 124 is formed on an inner surface of the sidewall 12 below the through hole 122.

The first connector 30 includes a main body 32 with two elastic hooks 322 extending from opposite sides of the main body 32. A panel 324 is formed on a first end of the main body 32. The panel 324 defines a plurality of sockets 3242 for electrically connecting other electronic devices. A plurality of pins 326 are set on a second end of the main body 32 and electrically connected to the sockets 3242.

The second connector 40 is substantially L-shaped, and includes a first connecting portion 42, and a second connecting portion 44 extending downward from a first end of the first connecting portion 42. A second end 422 of the first connecting portion 42 opposite to the first end defines a plurality of sockets 424. The second connecting portion 44 includes a mounting post 444 and a plurality of pins 442 electrically connected to the sockets 424. The mounting post 444 and pins 442 extend downward from a bottom of the second connecting portion 44 opposite to the first connecting portion 42.

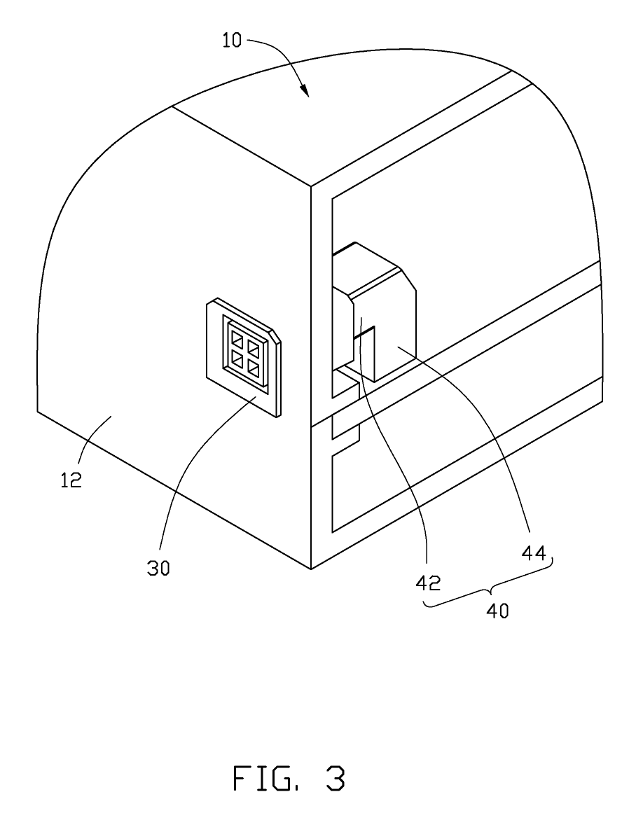

Referring to FIG. 3, in assembly, one end of the circuit board 20 is fixed to the locking portion 124. The first connector 30 is arranged in the through hole 122. The panel 324 is exposed through the through hole 122. The main body 32 extends through the through hole 122 until the hooks 322 are locked to an inner surface of the side plate 12 adjacent to the through hole 122. The pins 326 are plugged into the sockets 424. The mounting post 444 is fixed to a portion of the circuit board 20 near the side plate 12. The pins 442 are electrically connected to the circuit board 20.

In this embodiment, the first connecting portion 42 is substantially perpendicular to the second connecting portion 44. In another embodiment, the first connecting portion 42 is rotatably connected to the second connecting portion 44, therefore, the angle between the first connecting portion 42 and the second connecting portion 44 may be adjusted to fit for connecting the first connector 30 and the circuit board 20.

The first connector 30 is connected to the circuit board 20 through the detachable second connector 40, which renders it convenient to disassemble or repair the first connector 30.

Even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. An electronic device, comprising:
a housing;
a circuit board arranged in the housing;
a first connector comprising a panel formed at a first end of the first connector and a plurality of pins extending from a second end of the first connector, the first connector extending through the housing, with the panel exposed outside the housing, the panel defining a plurality of first sockets; and
a second connector comprising a first connecting portion and a second connecting portion electrically connected to the first connecting portion, wherein the first connecting portion defines a plurality of second sockets for the pins of the first connector detachably plugging in, the second connecting portion forms a plurality of pins electrically connected to the circuit board.

2. The electronic device of claim 1, wherein the housing comprises a side plate, the side plate defines a through hole, the first connector comprises a main body extending through the through hole, a hook extends from one side of the main body for being locked to an inner surface of the side plate adjacent to the through hole.

3. The electronic device of claim 1, wherein the first connecting portion is substantially perpendicular to the second connecting portion.

4. The electronic device of claim 1, wherein an angle between the first connecting portion and the second connecting portion is adjustable.

5. The electronic device of claim 1, wherein the second connecting portion forms a mounting post fixed to the circuit board.
